(19) United States
(12) Patent Application Publication
(10) Pub. No.: US 2003/0211246 A1
(43) Pub. Date: Nov. 13, 2003

(54) Additive electronic circuits on thermally unstable substrates

(76) Inventors: Paul H. Kydd, Lawrenceville, NJ (US); David L. Richard, Fanwood, NJ (US); Yvonne M. Kunz, Hopewell, NJ (US)

Correspondence Address: Stuart H Nissim, Woodbridge & Associates, PO Box 112, Princeton, NJ, 08542, US

(21) Appl. No.: 10/276,118

(22) PCT Filed: May 11, 2001
(86) PCT No.: PCT/US01/15321

(51) Int. Cl. B05D 1/32; B05D 3/02

(52) U.S. Cl. 427/282; 427/383.1

(57) ABSTRACT

A method of printing electronic circuits and components on polymers which would normally distort at the cure temperature of the metallic printing inks is disclosed. The method consists of restraining the polymer film either mechanically or by laminating it to a rigid backing. The rigid backing can be temporary and reusable or it can be a permanent part of the product.

### CROSS REFERENCE TO RELATED APPLICATIONS

This application claims priority from U.S. provisional application 60/204,056 filed May 12, 2000.

### BACKGROUND OF THE INVENTION

A common method for printed circuit fabrication process is subtractive or semi-additive processes in which conductors are formed by etching away unwanted copper. A fully additive process would have many advantages over the subtractive or semi-additive methods. The primary problem in providing a wholly additive process for producing printed circuitry is the requirement for high electrical conductivity with low enough curing temperature to be compatible with the polymer-based circuit boards. Another major problem is making connections to the additive traces, preferably by conventional soldering. Present technology includes low cure temperature conductive epoxies and transient liquid phase materials which produce traces with poor electrical conductivity and poor solderability or high temperature thick film inks which produce traces with good electrical conductivity and good solderability but which are limited to ceramic substrates. These small, expensive and specialized substrates are required to withstand the thick film ink firing temperatures of more than 650° C. and usually above 850° C . A method which could duplicate the performance of thick film inks but on polymer-based substrates at 250 to 350° C. would permit application of this technology broadly in the $27 billion rigid circuit board industry and the $2.5 billion flexible circuit industry, worldwide.

A novel family of low cure temperature compounds is commercially available as PARMOD™ compositions from Parelec, LLC, and are disclosed in Applicants' co-pending U.S. application Ser. No. 09/367,783 (corresponding to PCT Application PCT/US97/16226 filed Sep. 12, 1997), the contents of which in total is incorporated herein by reference. These compositions can be formulated into printing inks or pastes and liquid toners. These inks and toners can be printed on a substrate and cured to well-consolidated pure metal in seconds. The fast curing capability of PARMOD™ compositions, as well as their ease of application, males it possible to use them to create complex circuit patterns and thin metal objects by very simple and low-cost processes. An example of such an object is a pattern of electrical conductors used as an antenna in a radio frequency identification tag. Another such application is as a TAB bonding decal for semiconductors. Electronic circuit patterns of many types can be produced by this process and bonded to various types of substrates and devices. the method can be used to produce strain gauges, thermocouples and other types of instrumentation. Many other such objects and applications will be evident to those skilled in the art.

The PARMOD™ compounds contain a Reactive Organic Medium (ROM) and a source of metal, preferably metal flakes, metal powders and their mixtures. The ROM consists of either a Metallo-Organic Decomposition (MOD) compound or an organic reagent which can form such a compound upon heating in the presence of the metal source. The ingredients are blended together with rheology modifying organic vehicles well known in the art, if necessary, to produce printing inks or pastes or liquid toners. These inks, pastes and toners can be printed on a substrate and cured to well-consolidated films, traces and objects of pure metal in seconds.

The PARMOD™ compositions can be printed directly on a substrate to be used in the final product, and it would therefore be important to obtain a good bond to the substrate. Furthermore, the substrate would have to withstand the temperatures at which the PARMOD™ compositions cure to solid metal. These requirements impose severe restraints on the substrate materials which have to have a surface or a coating to which PARMOD™ will bond and have to have high temperature capability. Both requirements tend to limit the selection and increase the price of the substrate. This is particularly difficult in that the low cost copper PARMOD™ mixture requires the highest cure temperature and is limited to expensive polyimide substrates. The present application describes a method of printing on low-cost, heat-sensitive substrates such as polyester, which broadens the applicability of Parmod™ inks, pastes, and toners.

### SUMMARY OF THE INVENTION

Parmod™ materials have been developed for printing on polymer substrates such as those used for printed wiring boards and flexible circuits. They offer the advantage that electrical conductors consisting of a pure, single-phase metal or oxide can be produced by a simple print-and-heat process, instead of by the usual multi-step photolithographic etching process. The present invention provides for the direct printing and curing of PARMOD™ compositions on a thermally unstable substrate that is supported during the thermal curing cycle to eliminate distortion. The support may take the form of a mechanical restraint, such as a tenter frame, or it may be a temporary or permanent rigid backing material.

### DETAILED DESCRIPTION OF THE INVENTION

PARMOD™ mixtures contain a Reactive Organic Medium (ROM) and a metal composition comprised of metal flakes, metal powders, metal oxides, or combinations thereof. Examples of metals which can be used include copper, silver, gold, zinc, cadmium, palladium, iridium, ruthenium, osmium, rhodium, platinum, iron, cobalt, nickel, indium, tin, antimony, lead, manganese and bismuth. IndiumTinOxide is an example of a metal oxide used in PARMOD™ compositions. The ROM consists of either a Metallo-Organic Decomposition (MOD) compound or an organic reagent, which can form such a MOD compound upon heating in the presence of the metal composition. The ingredients are blended together with organic vehicles, if necessary, to produce printing inks or pastes or toners for electrostatic printing. These inks and toners can be printed on a temperature-sensitive substrate and cured to well-consolidated, well-bonded electrical conductors at a temperature low enough so that the substrate is not damaged. The curing process occurs in seconds at temperatures as much as 500° C. below those used for conventional sintering of thick film inks and pastes. Examples of PARMOD™ ink compositions are described in U.S. Pat. No. 5,882,722 issued on Mar. 16, 1999, the contents of which in total is incorporated herein by reference. PARMOD™ based toners useful for electrostatic printing are disclosed in U.S. Pat. No. 6,153,348 issued on Nov. 28, 2000, the contents of which in total is incorporated herein by reference. Parmod™ mixtures function by deposition of material from decomposition of the MOD compound which “chemically welds” the metal composition constituents of the mixture together into a monolithic solid. In the case of metals, this results in a porous but continuous metal trace which has a density approximately half that of bulk metal and an electrical conductivity per unit mass which is also approximately half that of the bulk metal. This demonstrates that the printed Parmod™ conductors are made up of continuous well-bonded metal, rather than of individual particles that are in adventitious contact with each other, as in so-called polymer thick film materials.

Parmod™ compositions for printing electrical conductors and passive components such as resistors and capacitors cure at temperatures from 200 to 350° C. There are a number of desirable polymer substrates which can withstand this temperature in terms of thermal decomposition but are subject to thermal distortion. This is particularly true of materials such as polyethylene terephthalate (PET) polyester, which is widely available as DuPont “Mylar” film and other trademarks. Other useful polymers include, for example, polyesters, polyethylene naphthenate (e.g., ICI/DuPont Kaladex®) and polyether ketones (e.g., GE Ultem®). Other polymers possessing desirable mechanical, electrical and thermal properties but inadequate dimensional stability can also be used including, for example, acrylics, polyanides, polylirethanes, polyimides, polycarbonates, polyolefins, polyamidimides, and liquid crystal polymers. These polymers derive their very favorable mechanical properties by being crystallized after casting or extrusion from the melt. The as-cast polymer sheet is stretched in two dimensions by as much as a factor of 10 in area to align the polymer molecules and increase the rigidity of the finished film.

Parmod™ materials can be printed on these polymers and cured to provide good electrical properties and good adhesion. The films themselves, however, when reheated to the temperature at which they were processed, relax their crystal structure and shrivel up to approximately their original extent. This is clearly unacceptable for electronic circuitry that has to maintain accurate dimensional stability to match the components to be assembled onto the circuit and to permit formation of multilayer structures with good registration between layers.

The solution to this problem, which is disclosed herein, is to support the polymer film in such a way that its shrinkage is restrained during the thermal cure process to maintain the original printed dimensions of the circuitry. This can be done in two ways:

1) Mechanical restraint of the film in the curing oven, as by a vacuum chuck or tenter frame.

2) Lamination of the thermally unstable film to a thermally stable backing, which may or may not be part of the final product.

Mechanical Restraint

This method essentially duplicates the process by which the film is made in order to prevent its distortion on reheating. The electronic circuitry is printed on the film by standard methods such as screen printing, stenciling, dispensing, gravure printing, ink jet printing, impression printing, offset printing and electrostatic printing. The film is then restrained, such as by grasping by a mechanical frame or a vacuum chuck to hold it rigidly in position as it is heat treated to cure the Parmod™ material. Typically these circuits are cured in a belt furnace in which the printed panels are placed on a stainless steel mesh belt and drawn through the furnace in which it is exposed to a specified time-temperature profile. Films that tend to stick to the belt are supported by nonstick pallets of, for example, glass-reinforced Teflon. In large-scale production the same effect would be produced by running a continuous web of printed film through the furnace.

In one preferred embodiment of this invention the nonstick pallets are replaced by a porous Teflon-glass laminate or similar material. These porous pallets are equipped with means to maintain a continuous suction through the porous material to hold the film firmly on the surface. This restraint needs to be adequate to ensure that the film cannot change dimensions during the curing cycle. Additional constraint can be imposed by providing structure to the surface of the pallet such as surface roughness or a groove or step near the edge to prevent shrinkage.

Another embodiment,, which is particularly suited to roll-to-roll production of printed circuits, is to use a tenter frame, similar to the machine used to originally stretch the film in two dimensions. This provides a series of grips on two chains moving at the same speed as the belt or the web. The grips sequentially grip both edges of the web and hold it in relatively the same position as it passes through the hot zone, allowing it to cool under tension to maintain the original dimensions until the film becomes rigid again. Some tension along the film direction can be provided by controlling the speed of the unwinding and winding drums or one or more intermediate tension rolls to help stabilize the film in the length direction.

Lamination Restraint

In another embodiment the unstable polymer film is laminated to a temporary or permanent backing which is rigid enough to maintain the film dimensions during the curing process. The requirements for these backings are that they must be able to survive the time-temperature profile required to cure the conductors, and to accommodate these conditions many times for temporary, reusable backings. They must be rigid enough to avoid curling and distortion during the cure process. They must be easily handled as panels for a batch process, or flexible enough to pass over rollers in a roll-to-roll process. They must be inexpensive if used once, or long lived if used many times for economic reasons.

Temporary backings which are suitable include polyimide films, polysulfone films, polyester films, Teflon coated films, silicone coated films, metal foils, metal, glass, ceramic, and paper products and laminates of Teflon-glass, polyimide-glass, epoxy-glass, polyester-glass or any of the above with other reinforcements such as aramid fibers. In the case of laminates, the reinforcing material preserves dimensional stability in the X-Y directions, and the thickness of the laminate resists curling. High temperature polymers such as polyimides may be used. Metals such as polished stainless steel can be used. Ceramics such as alumina can be used for batch use and also ceramic-coated metal belts.

In implementing this process the polymer film is first laminated to the rigid backing to provide a supported film. This can be done by laminating a preexisting film under heat and pressure to the temporary backing. The film should be raised to a temperature above its glass transition point at which temperature it softens and can adhere to the temporary backing. The film is constrained to adhere to the backing without shrinking by means of caul plates applying pressure in a laminating press or by other means well known in the art.

Such a supported film can also be made by extruding or casting the resin upon the temporary backing, although in this case the advantage of stretching and crystallization of the film is lost.

The conductor/component pattern is printed on the resin film using Parmod™ ink, toner, or the like and cured in a furnace. The bond between the film and the temporary backing prevents the film from shrinking during the cure cycle, even though the film softens enough to allow the cured traces to bond to it. Components such as integrated circuits can be placed on the uncured Parmod™ traces so that they are bonded to the traces as the traces themselves are cured. Such a method is disclosed in U.S. Pat. No. 6,036,889 issued Mar. 14, 2000, hereby incorporated in its entirety by reference. Other components can be printed on the film, cured and bonded to the traces in subsequent and repeated operations to make a fully populated circuit. Another layer of polymer film with punched or drilled holes to provide attachment pads to the outside world may be added and bonded under pressure to produce a finished flexible circuit with a coverlay with the metal traces at the neutral axis for maximum strength and durability. Alternatively, another set of traces can be printed on the second layer of polymer film and a multilayer structure built up of any desired complexity.

The finished panel of circuitry must be carefully separated from the temporary backing to avoid sharp creases and damage to the circuitry. This may be done by putting the circuit in contact with a vacuum chuck and peeling the temporary backing off it keeping the circuitry flat. The same objective can be achieved by cementing the polymer film onto a rigid support such as a FR-4 laminated circuit with a suitable adhesive. Yet another method of removing the temporary backing is to injection mold a part onto the polymer film to provide a molded interconnect structure, and separate the temporary backing from the finished part.

Permanent Backings

A preferred permanent backing for the process of this invention is paper or cardboard. Paper products are advantageous because cellulose does not melt or soften under the cure conditions for Parmod™. Another major advantage of paper products is that they are inexpensive and consequently widely used for packaging applications on which it may be desired to install electronic circuitry for Radio Frequency Identification (RFID). There is a wealth of experience and equipment for printing on paper products and for laminating various polymer coatings to paper. In this case the polyester or other film is laminated onto the paper, for example card stock, or cast directly on it to make coated panels or rolls. The coated stock is printed with the desired circuitry and cured in an oven. A nitrogen atmosphere may be used to allow higher cure temperatures without scorching or discoloring the paper, and to improve the adhesion of the Parmod™. Several printing operations may be used to print additional components and additional layers of circuitry may be added to make a finished multilayer circuit.

### EXAMPLES

The examples described below indicate individual constituents of preferred compositions and the methods and conditions for applying them to provide the desired result. The examples will serve to further typify the nature of this invention, but should not be construed as a limitation in the scope thereof which scope is defined solely in the appended claims.

### Example 1

A silver PARMOD™ screen ink was prepared as follows. 12.0 grams of Degussa silver flake, 3.0 grams of silver neodecanoate, and 1.35 grams of neodecanoic acid were mixed together using a spatula. The resulting mixture was then milled on a roll mill to give a homogeneous paste.

### Example 2

Copper PARMOD™ ink was prepared by mixing 47 grams of copper flake, 29 grains of nanometer sized spherical copper powder mixed with neodecanoic acid (−77 wt % metal) and 15 grams of neodecanoic acid in a glove box. This premix was than further mixed on a 2-roll mill for 30 minutes in air. The gap setting on the mill was 0.006″-0.008″.

### Example 3

Gold PARMOD™ ink was prepared by mixing 8 parts by weight gold flake, 1 part by weight gold neodecanoate, and 1 part by weight gold amine 2-ethyl hexanoate. The mixture was combined and blended by hand in a glove box and then roll milled in air to produce a homogeneous ink.

### Example 4

Printing on Polyester-Coated Paper

Westvaco Printkote Ovenable paper with an 0.018 coating of polyester was direct printed on the polymer coated side. Parmod™ silver ink was screen printed onto the paper backing. A 600-square serpentine test pattern was used with screen parameters of 230 mesh, 1.4 mil wires at 450 to the trace direction, and a 1.1 mil emulsion.

The following thermal cure treatment was applied in a three-zone belt furnace:

1. T₁=200° C., T₂=210° C., T₃ as shown, speed=7.0 in/min (5.7 minutes in the hot zone), air atmosphere.

2. T₁=200° C., T₂=210° C., T₃ as shown, speed=7.0 in/min (5.7 minutes in the hot zone), nitrogen atmosphere.

| Cure | | | | | |
|---|---|---|---|---|---|
| Temp | | Ω/600 | Appearance- | Appearance- | Tape |
| deg. C. | Atmosphere | squares | silver edges | paper | Test* |
| 220 | air | 1.36 | White | Slight discolor | 1 |
| 230 | | 1.5 | ″ | More | 1 |
| 240 | | 1.5 | ″ | Tan | 3 |
| 245 | | 1.6 | ″ | ″ | 5 |
| 250 | | 1.6 | ″ | ″ | 5 |
| 240 | N2 | 11.4 | ″ | ″ | 2 |
| 245 | | 2.6 | ″ | ″ | 5 |
| 250 | | 2.4 | ″ | ″ | 5 |
| 260 | | 1.7 | ″ | ″ | 5 |

*Scotch brand tape applied to the silver trace and peeled of. Adhesion varies from 1 (poor, all silver removed) to 5 (good, no silver removed).

### Example 5

### Printing on DuPont Kapton® ELJ Polyimide Film

Kapton® ELJ is a coated polyimide film produced by DuPont. It consists of a a 0.001 inch thick Kapton® E core coated on each side with a 0.0005 inch thick layer of Kapton® LJ low temperature polyimide adhesive. Seven inch by three inch circuits printed with Parmod™ copper ink on DuPont Kapton® ELJ film shrank approximately 1.5% in the short direction and 0.5% in the long direction. The film itself shrank by an average of 1.15% in the short direction and 0.5% in the long direction. Kapton® H, which is an uncoated film similar to the Kapton® E core showed negligible shrinkage in either direction.

Kapton® ELJ films were constrained by laminating them to 1.5 mm thick Allied Signal P-95 polyimide-glass laminate under 750 psi pressure at 330 C. for an hour. The same seven inch by three inch copper Parmod™ circuits were printed on the constrained films and cured at 330° C. for ten minutes in nitrogen. Following cure the printed circuits aligned perfectly with the original artwork from which the printing screen bad been made. The shrinkage was less than 0.08% in the short direction and 0.04% in the long direction. Following cure the film could easily be stripped off the P-95 support.

What is claimed:

1. A method for producing one or more patterns of metal conductors and objects on a thermally unstable polymer film comprising the steps of:
a) restraining the polymer film;
b) applying a metal composition which can be thermally cured at temperatures below about 500° C. to form essentially pure metal conductors to the polymer film in the patterns of the one or more patterns of metal conductors and objects;
c) curing said metal composition with heat to form the one or more patterns of metal conductors and objects.

2. The method of claim 1 wherein the polymer is restrained using a method selected from the group consisting of vacuum, tenter frame, and lamination to a backing.

3. The method of claim 2 wherein said lamination to a backing is permanent or temporary.

4. The method of claim 3 wherein said backing is selected from the group consisting of polyimide films, polysulfone films, polyester films, Teflon coated films, silicone coated films, metal foils, metal, laminate, glass, ceramic, and paper products.

5. The method of claim 4 wherein said paper product backing is polymer coated.

6. The method of claim 3 wherein said backing is a continuous belt or a rigid panel.

7. The method of claim 1 wherein said metal composition is applied to said polymer film using a method selected from the group consisting of screen printing, stenciling, dispensing, gravure printing, ink jet printing, impression printing, offset printing and electrostatic printing.

8. The method of claim 1 wherein said polymer is selected from the group consisting of polyesters, PET, polyethylene naphthenate, polyether ketones, acrylics, polyamides, polyurethanes, polyimides, polycarbonates, polyolefins, polyamidimides, and liquid crystal polymers.

9. The method of claim 1 wherein said metal composition is comprised of metal particles and a reactive organic medium, wherein said reactive organic medium is comprised of a decomposable compound or one or more reagents which form a decomposable compound with said metal particles

10. The method of claim 9 wherein said metal particles are selected from the group consisting of metal flakes, metal spheres, metal colloids, and mixtures thereof.

11. The method of claim 9 wherein said metal particles are selected from the group consisting of copper, silver, gold, zinc, cadmium, palladium, iridium, ruthenium, osmium, rhodium, platinum, iron, cobalt, nickel, indium, tin, antimony, lead, manganese and bismuth

12. The method of claim 1 further comprising the step of removing the polymer film from said restraint after curing.

13. The method of claim 1 further comprising the step of bonding a coverlay to the cured polymer film.

14. The method of claim 1 in which steps b) and c) are repeated one or more times.

15. The method of claim 1 further comprising the step of bonding components to said polymer film with said metal composition before the curing of step c).
